(19) United States
(12) Patent Application Publication
(10) Pub. No.: US 2014/0321159 A1
(43) Pub. Date: Oct. 30, 2014

(54) LIGHT GUIDE PLATE AND BACKLIGHT MODULE HAVING SAME

(71) Applicant: HON HAI PRECISION INDUSTRY CO., LTD., New Taipei (TW)

(72) Inventor: CHEN-HAN LIN, New Taipei (TW)

(73) Assignee: HON HAI PRECISION INDUSTRY CO., LTD., New Taipei (TW)

(21) Appl. No.: 14/262,796

(22) Filed: Apr. 27, 2014

(30) Foreign Application Priority Data
Apr. 26, 2013 (TW) 102115128

(51) Int. Cl. F21V 8/00

(52) U.S. Cl. CPC G02B 6/0031
USPC 362/609

(57) ABSTRACT

A backlight module includes a light guide plate and a light source module. The light guide plate includes a light incident surface. The light incident surface forms a sector-cylinder-shaped cutout on the light guide plate. The light source module includes tricolor lasers, two spectroscopes and a MEMS mirror. The tricolor lasers are arranged opposite to the light guide plate. The two spectroscopes are respectively arranged opposite to two of the tricolor lasers. The two spectroscopes respectively reflect light emitted from two of the tricolor lasers, and transmit the light emitted from the others. Thus, white light is achieved after the light emitted from the tricolor lasers passes through the two spectroscopes. The MEMS mirror is arranged opposite to the light incident surface for reflecting the white light and rotating to form a scanning light beam, which finally enters into the light guide plate through the light incident surface.

### FIELD

The present disclosure relates to a light guide plate and a backlight module having the light guide plate.

### BACKGROUND

A backlight module can include a light source, a light guide plate, and an optical film unit. The light source is a white light source mixed by tricolor light emitting diodes (LED), which needs a great area to mix the tricolor light.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, side view of a backlight module according to a first embodiment.

FIG. 2 is a schematic view of a light source module and a light guide plate of the backlight module in FIG. 1.

FIG. 3 is a schematic, enlarged view of a III portion in FIG. 2.

FIG. 4 is a schematic view of light source module and a light guide plate of a backlight module according to a second embodiment.

FIG. 5 is a schematic view of light source module and a light guide plate of a backlight module according to a third embodiment.

### DETAILED DESCRIPTION

The disclosure is illustrated by way of example and not by way of limitation in the figures of the accompanying drawings in which like reference numbers indicate similar elements. It should be noted that references to “an” or “one” embodiment in this disclosure are not necessarily to the same embodiment, and such references mean “at least one.” The references “a plurality of” and “a number of” mean “at least two.”

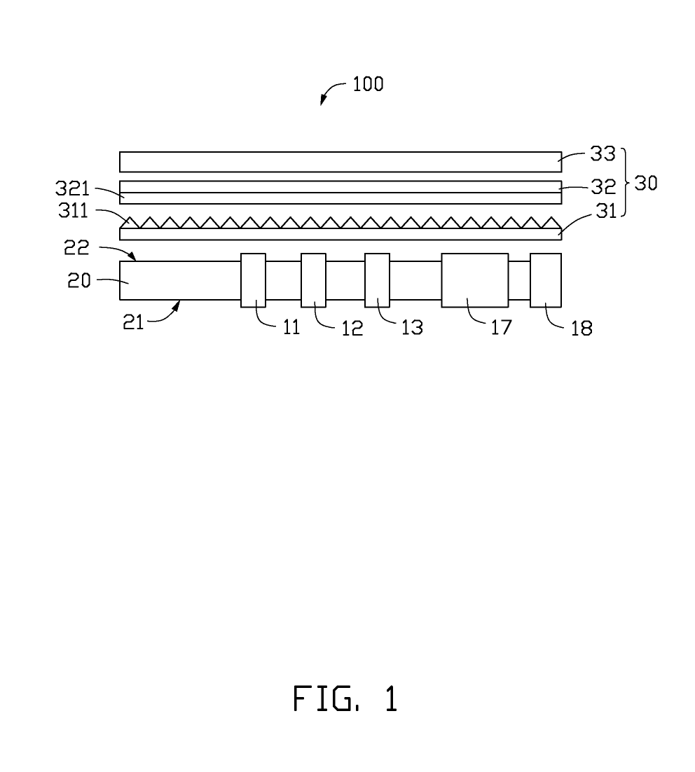

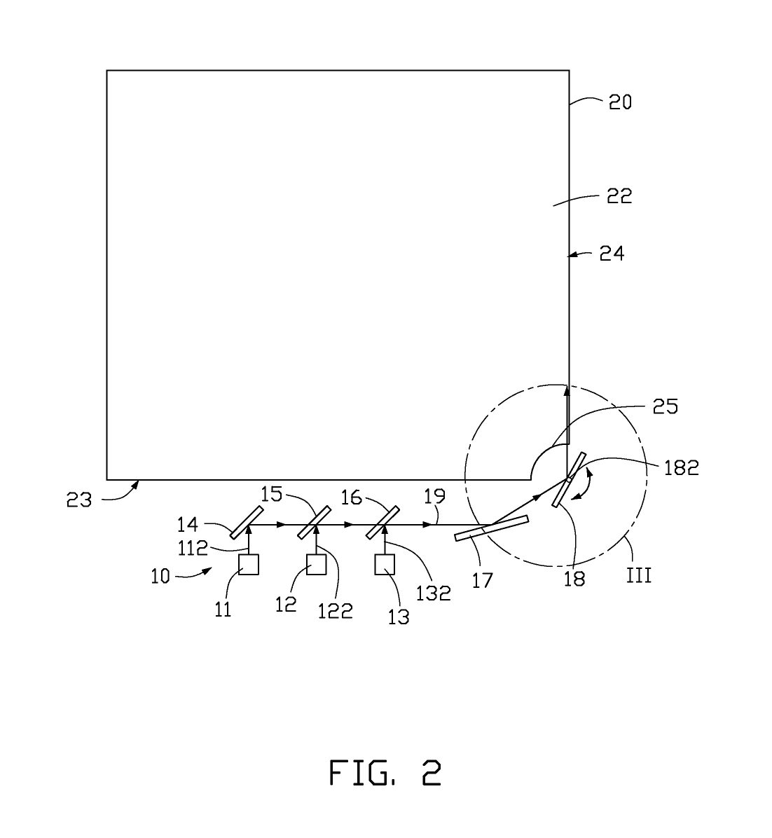

FIGS. 1-2 illustrate a backlight module 100 according to a first embodiment. The backlight module 100 includes a light source module 10, a light guide plate 20, and an optical film unit 30.

The light source module 10 includes a first laser light source 11, a second laser light source 12, a third laser light source 13, three spectroscopes 14, 15, 16, a reflecting element 17, and an micro-electromechanical system (MEMS) mirror 18.

In this embodiment, the first laser light source 11, the second laser light source 12, and the third laser light source 13 are all laser diodes. The first laser light source 11 is configured for emitting red laser beam 112. The second laser light source 12 is configured for emitting green laser beam 122. The third laser light source 13 is configured for emitting blue laser beam 132.

The three spectroscopes 14, 15, 16 are parallel with each other and are separately located on the light emitting directions of the first laser light source 11, the second laser light source 12, and the third laser light source 13. Each of the three spectroscopes 14, 15, 16 can be configured for reflecting one of the red laser beam 112, of the green laser beam 122, and of the blue laser beam 132 and allow the other two laser beams to pass through. In detail, the spectroscope 14 can be configured for reflecting the red laser beams 112 emitting from the first laser light source 11. The red laser beam 112 is reflected by the spectroscope 14 then can pass through the spectroscope 15 and the spectroscope 16. The spectroscope 15 can be configured for reflecting the green laser beam 122 emitted from the second laser light source 12. The green laser beams 122 are reflected by the spectroscope 15, and then can pass through the spectroscope 16. The spectroscope 16 can be configured for reflecting the blue laser beam 132 emitting from the third laser light source 13. The red laser beam 112, the green laser beam 122, and the blue laser beam 132 reflected or allowed by the spectroscope 16 are synthesized to form a synthesized white laser beam 19.

The reflecting element 17 is arranged between the spectroscope 16 and the MEMS mirror 18. The reflecting element 17 can be configured for reflecting the synthesized white laser beam 19 to the MEMS mirror 18.

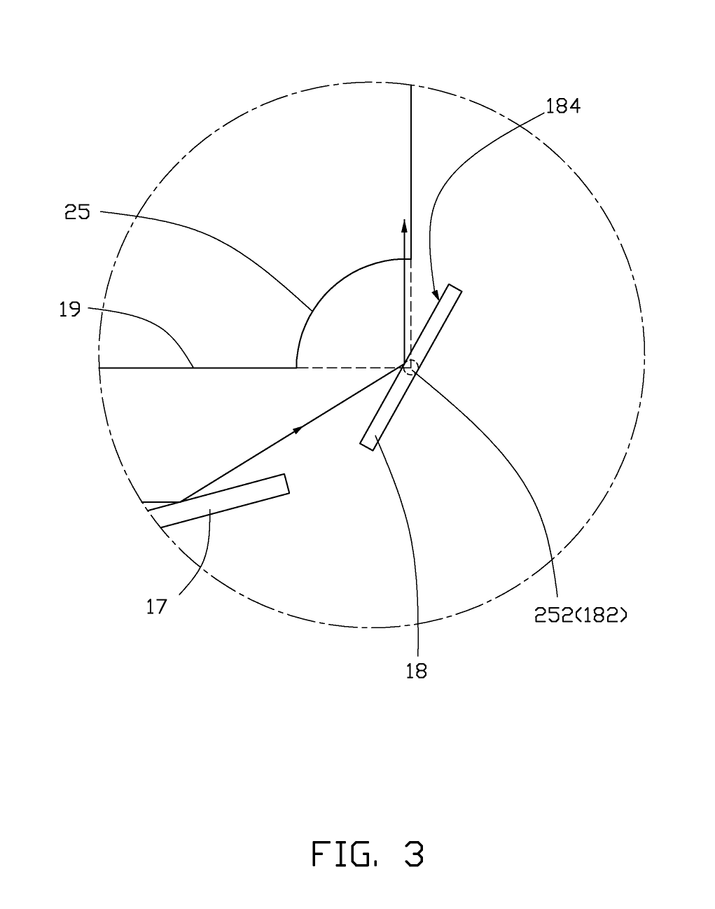

FIG. 3 illustrates the MEMS mirror 18 can be configured for reflecting the synthesized white laser beam 19 reflected from the reflecting element 17 toward the light guide plate 12. The MEMS mirror 18 includes a rotating shaft 182 and a reflecting surface 184. The MEMS mirror 18 is connected to a piezoelectric driver (not shown), and can be driven to do reciprocating motion in a predetermined range and in a predetermined frequency.

In this embodiment, the light guide plate 20 is rectangular. The light guide plate 20 includes a bottom surface 21, a light incident surface 25, a light emitting surface 22 that is facing and is parallel with the bottom surface 21, a first side surface 23, and a second side surface 24. The first side surface 23, the light incident surface 25, and the second side surface 24 can be interconnected in the described order and are interconnected between the bottom surface 21 and the light emitting surface 22.

The first laser light source 11, the second laser light source 12, and the third laser light source 13 all face the first side surface 23. The light emitting directions of the first laser light source 11, the second laser light source 12, and the third laser light source 13 are all parallel with the light emitting surface 22. In this embodiment, the light emitting directions of the first laser light source 11, the second laser light source 12, and the third laser light source 13 are all perpendicular to the first side surface 23.

In this embodiment, the three spectroscopes 14, 15, 16 can be arranged between the three laser light sources 11, 12, 13 and the first side surface 23. The three spectroscopes 14, 15, 16 are all plate-shaped. The three spectroscopes 14, 15, 16 are defined at a 45 degrees angle with respect to the first side surface 23.

The light incident surface 25 faces the MEMS mirror 18. The light incident surface 25 is curved and is recessed into the light guide plate 20. In this embodiment, the light incident surface 25 forms a sector-cylinder-shaped cutout on the light guide plate 20. The axis of the sector-cylinder-shaped cutout can be perpendicular to the light emitting surface 22. In this embodiment, the central angle of the sector-cylinder-shaped cutout is 90 degrees, and the central axis of the sector-cylinder-shaped cutout is superposed with an intersecting line of the first side surface 23 and the second side surface 24, and also superposed with a central axis of the rotating shaft 182 of the MEMS mirror 18.

The optical film unit 30 is arranged opposite to the emitting surface 22 of the light guide plate 20. The synthesized white laser beam 19 transmitted through the MEMS mirror 18 irradiates the optical film unit 30. The optical film unit 30 includes a first prism 31, a second prism 32, and a diffusion film 33 arranged in the described order, and the first prism 31 is nearest to the emitting surface 22. A plurality of first microstructures 311 is formed on a surface of the first prism 31 away from the light emitting surface 22. A plurality of second microstructures 321 is formed on a surface of the second prism 32 facing the first prism 31. In this embodiment, the microstructures 311, 321 on the first prism 31 and the second prism 32 are all triangular prism. The first microstructures 311 are parallel with each other in their extended direction. The second microstructures 321 are parallel with each other in their extended direction. The extended direction of the first microstructures 311 are perpendicular to the extend direction of the second microstructures 321.

In use, the synthesized white laser beam 19 is converged by the reflecting member 17 toward the MEMS mirror 18, and then is reflected by the MEMS mirror 18 to form a scanning light beam into the light guide plate 20 through the light incident surface 25. Finally, the synthesized white laser beam 19 can be emitted out from the light guide plate 20 through the light emitting surface 22. The synthesized white laser beam 19 can be equally emitted from the light emitting surface 22, when the MEMS mirror 18 is driven to do reciprocating motion in a predetermined range and in a predetermined frequency. Sizes of the laser light sources, the spectroscopes, and the MEMS mirror are all small, which is suitable for small size LCD.

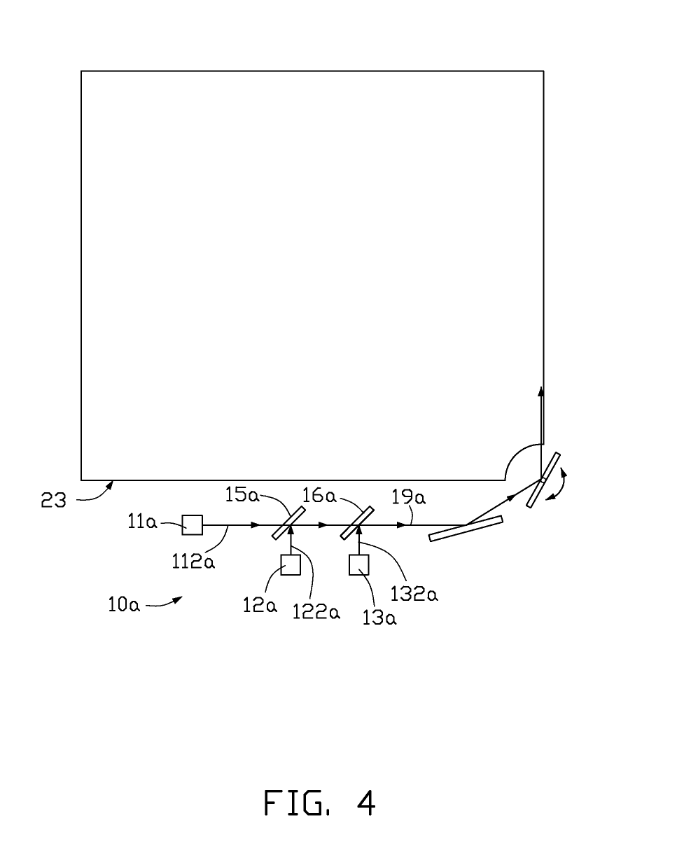

FIG. 4 illustrates that a backlight module 10a is provided according to a second embodiment. The backlight module 10a is similar to the backlight module 100 in the first embodiment. However, the spectroscope 14 is omitted, and the first laser light source 11a of the backlight module 10a is arranged on a side of the spectroscope 15a away from the spectroscope 16a. The light emitting direction of the first laser light source 11a is parallel with the first side surface 23 and the light emitting surface 22. The red laser beam 112a enters into the spectroscope 15a, and then emits from the spectroscope 15a toward the spectroscope 16a, and passes through the spectroscope 16a. The green laser beam 122a is reflected by the spectroscope 15a, and then can pass through the spectroscope 16a. The spectroscope 16a reflects the blue laser beam 132a. The red laser beam 112a, the green laser beam 122a, and the blue laser beam 132a reflected or allowed by the spectroscope 16a are combined to form a synthesized white laser beam 19a.

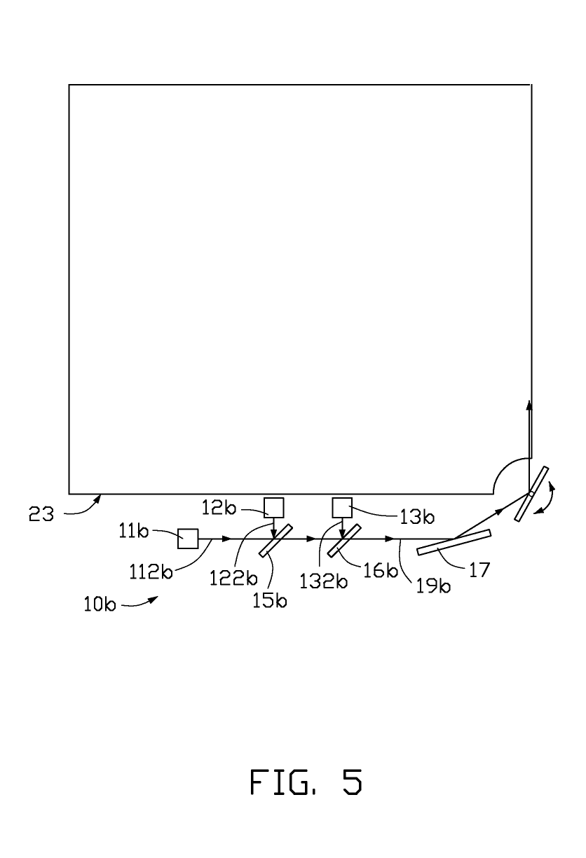

FIG. 5 illustrates that a backlight module 10b is provided according to a third embodiment. The backlight module 10b is similar to the backlight module 10a in the second embodiment. However, the second laser light source 12b is arranged between the first side surface 23 and the spectroscope 15b, and the third laser light source 13b is arranged between the first side surface 23 and the spectroscope 16b. In this embodiment, the spectroscope 15b and the spectroscope 16b are achieved by turning the spectroscope 15a and the spectroscope 16a to rotate in a 90 degree angle with respect to an axis perpendicular to the first side surface 23.

In other embodiments, the three laser light source 11, 12, 13 also can be arranged between the first side surface 23 and the three spectroscopes 14, 15, 16 in the FIG. 2.

In other embodiments, the reflecting element 17 can be omitted.

In other embodiments, the three laser light source 11, 12, 13 can be exchanged.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A backlight module, comprising:
a light guide plate comprising a light incident surface, the light incident surface being curved and recessed into the light guide plate to form a sector-cylinder-shaped cutout on the light guide plate; and
a light source module, comprising:
a first laser light source, a second laser light source, and a third laser light source arranged on a side of the light guide plate, the three laser light source configured for emitting tricolor laser beams;
two spectroscopes, each of the two spectroscopes being corresponding to and facing one of the second and third laser light sources, the spectroscope corresponding to the second laser light source configured for reflecting the laser beam emitted from the second laser light source, and for passing through the laser beam emitted from the first laser light source, the spectroscope corresponding to the third laser light source configured for reflecting the laser beam emitted from the third laser light source, for passing through the laser beams reflected and allowed by the spectroscope corresponding to the second laser light source, and for combining the tricolor laser beams emitted from the three laser light source to synthesize a white laser beam; and
a MEMS mirror comprising a reflecting surface facing the light incident surface, the MEMS mirror being driven to do reciprocating motion in a predetermined range and in a predetermined frequency, the MEMS mirror configured for reflecting the synthesized white laser beam synthesized from the two spectroscopes toward the light guide plate.

2. The backlight module of claim 1, wherein the light source module further comprises a spectroscope corresponding to the first laser light source and configured for reflecting the laser beam emitted from the first laser light source.

3. The backlight module of claim 4, wherein the three spectroscopes are all arranged between the corresponding one of the three laser light sources and the light guide plate.

4. The backlight module of claim 4, wherein the three laser light source are all arranged between the corresponding one of the three spectroscopes and the light guide plate.

5. The backlight module of claim 1, wherein the two spectroscopes are arranged between the corresponding one of the second and third laser light sources and the light guide plate.

6. The backlight module of claim 1, wherein the second and third laser light source are arranged between the corresponding one of the two spectroscopes and the light guide plate.

7. The backlight module of claim 1, wherein the light guide plate further comprises a bottom surface, a light emitting surface, a first side surface, and a second side surface, the light emitting surface facing and parallel with the bottom surface, the first side surface, the light incident surface, and the second side surface being interconnected in the described order and being interconnected between the bottom surface and the light emitting surface.

8. The backlight module of claim 7, wherein the first, second, and third laser light source all face the first side surface, the light emitting directions of the first, second, and third laser light sources are all parallel with the light emitting surface.

9. The backlight module of claim 8, wherein the two spectroscopes are defined at a 45 degrees angle with respect to the first side surface.

10. The backlight module of claim 8, wherein the axis of the sector-cylinder-shaped cutout is perpendicular to the light emitting surface.

11. The backlight module of claim 10, wherein the central angle of the sector-cylinder-shaped cutout is 90 degrees, and the central axis of the sector-cylinder-shaped cutout is superposed with an intersecting line of the first side surface and the second side surface.

12. The backlight module of claim 8, wherein the first, second, and third laser light sources are all arranged facing the first side surface, and the two spectroscopes are arranged between the corresponding one of the second and third laser light sources and the first side surface.

13. The backlight module of claim 8, wherein the first, second, and third laser light sources are all arranged facing the first side surface, and the second and third laser light sources are arranged between the corresponding one of the two spectroscopes and the first side surface.

14. The backlight module of claim 1, wherein the light source module further comprises a reflecting element, the reflecting element is arranged between the two spectroscopes and the MEMS mirror, and the reflecting element is configured for reflecting the synthesized white laser beams to the MEMS mirror.

15. The backlight module of claim 1, further comprising an optical film unit arranged on a side of the emitting surface of the light guide plate, the optical film unit comprising a first prism, a second prism and a diffusion film arranged in the described order, the first prism being nearest to the emitting surface, a plurality of first microstructures formed on a surface of the first prism away from the light emitting surface, a plurality of second microstructures formed on a surface of the second prism facing the first prism, the first microstructures being parallel with each other in their extended direction, the second microstructures being parallel with each other in their extended direction, the extended direction of the first microstructures being perpendicular to the extend direction of the second microstructures.

16. A light guide plate, comprising a light incident surface, the light incident surface being curved and recessed into the light guide plate to form a sector-cylinder-shaped cutout on the light guide plate.

17. The light guide plate of claim 16, further comprising a bottom surface, a light emitting surface, a first side surface, and a second side surface, the light emitting surface facing and parallel with the bottom surface, the first side surface, the light incident surface, and the second side surface being interconnected in the described order and being interconnected between the bottom surface and the light emitting surface.

18. The light guide plate of claim 17, wherein the axis of the sector-cylinder-shaped cutout is perpendicular to the light emitting surface.

19. The light guide plate of claim 18, wherein the central angle of the sector-cylinder-shaped cutout is 90 degrees, and the central axis of the sector-cylinder-shaped cutout is superposed with an intersecting line of the first side surface and the second side surface.
